(19) United States
(12) Patent Application Publication
(10) Pub. No.: US 2013/0015659 A1
(43) Pub. Date: Jan. 17, 2013

(54) Tidal Turbine System

(71) Applicant: Richard Ayre, Haverfordwest (GB)

(72) Inventor: Richard Ayre, Haverfordwest (GB)

(21) Appl. No.: 13/512,370

(22) PCT Filed: Nov. 30, 2010
(86) PCT No.: PCT/GB2010/051989

§ 371 Date: Sep. 30, 2012

(30) Foreign Application Priority Data
Dec. 3, 2009 (GB) 0921207.7

(51) Int. Cl. F03B 15/06; F03B 13/26

(52) U.S. Cl. 290/42

(57) ABSTRACT

A tidal flow energy generation system has tidal turbine generators and a controls system for controlling operation of the one or more tidal turbine generators and a flow determination device for determining variations in the flow at a distance from a respective turbine generator. The control system operates using input from the flow determination device to predict change in flow characteristics on course to impact on the turbine generators, such that an operational parameter of the turbine generator may be varied by the control system. The control system operating such that control of the turbine generator may be varied in response to input into the control means from the flow determination means. In this way, the system can operate to vary operation of the (or each) turbine generator in order to compensate for loading variations that will impact upon the turbine generator, the loading variations are predicted based upon the variations determined by the determination means. This reduces the risk of fatigue failure.

### CROSS-REFERENCE TO RELATED APPLICATIONS

This application claims priority from PCT/GB/2010/01989 filed on Nov. 30, 2010, and GB 0921207.7 filed on Dec. 3, 2009, both of which are hereby incorporated by reference in their entireties.

### BACKGROUND OF THE INVENTION

1. Field

The present invention relates to a tidal turbine system, particularly for use in a tidal flow energy generation system.

2. Related Art

Tidal energy is to a great extent predictable. The deterministic nature of the availability of power, together with its high density and the implicit absence of visual impact makes tidal energy extraction a very attractive proposition particularly since virtually the whole of the available resources remain untapped.

At water depths below significant wave effects generally changes in current flow are due to the naturally occurring phases of the moon and sun. Superimposed on this pattern is a variation of flow velocities, some reaching a considerable fraction of the free-stream values, and which are due to intense atmospheric events.

Prior art is known which suggests applying a control signal to a tidal turbine generator responsive to the velocity of the tidal water flow in order to control the efficiency of the turbine generator as the tidal flow velocity varies with time. Such an arrangement is disclosed, for example, in US2006/0232072.

Prior art is also known which suggests changing the attack angle of turbine blades dependent upon sensed flow direction. Such an arrangement is disclosed in, for example, US2003/0231951.

However it has been found that in sea bed mounted tidal flow generation structures the influence of pressure pulse variations in flow occurring at higher frequencies than the tidal change frequency can have a significant effect. Particularly turbulent flows and flows resulting from wave characteristics can have significant pressure pulse stress loading impact on the turbine. Unsteady loading as a result of these effects can cause fatigue in the components of the system which has the potential, if not ameliorated to significantly reduce the operational life of the system. Furthermore if flow velocities vary in an abrupt manner, this can cause the instantaneous turbine operation lead to a stall event.

### SUMMARY OF THE INVENTION

According to a first aspect, the present invention provides a tidal flow energy generation system comprising:

one or more tidal turbine generators;
control means for controlling operation of the one or more tidal turbine generators;
flow determination means for determining variations in the flow at a distance away from a respective turbine generator;
wherein the control means operates using input from the flow determination means to predict a change in flow characteristics on course to impact on the respective turbine such that an operational parameter of the turbine generator may be varied in response to the control means.

In this way, the system can operate to vary operation of the (or each) turbine generator in order to compensate for loading variations that will impact upon the turbine generator, the loading variations are predicted based upon the variations determined by the determination means. This reduces the risk of fatigue failure.

According to an alternative aspect, the invention provides a method of operating a tidal flow generation system, the method comprising determining (pressure pulse) variations in the flow at a distance from the generator, predicting the pressure pulse loading that will impact a respective turbine generator and varying operation of the turbine generator to compensate for the predicted pressure pulse loading.

Typically, the flow determination means is arranged to sense a pressure wave at a distance from the turbine generator and enable prediction of the pressure change that will occur at the turbine generator at a future instant.

Typically, the control means will calculate predicted impact time or input instant and control the operational parameter (typically varying the turbine speed) to accommodate the change at the required future instant in order to minimise the effect of pressure pulse event at the turbine generator.

Such a technique enables the effect of the pressure pulse created loading on the turbine generators to be compensated for, by appropriate variation in operation of the turbine generators. The effect of fatigue inducing stresses can be neutralised by ascertaining the anomalous wave effect or pressure loading that will shortly be impacting on the turbine generator and by knowing the distance and speed of approach of the pressure pulse anomalous flow effect the time at which the generator operation needs to be varied can be derived by the control system (and also the degree of variation in the operating parameters that is necessary).

It is preferred that the flow determination means comprises a flow measurement arrangement. This may be a sonar and/or Doppler device. In one embodiment an Acoustic Doppler Current Profiler (ADCP) may be used for this purpose.

The flow determination means is arranged to determine the flow at a distance way from the tidal turbine generator. Typically the flow will be measured a number of metres (5 to 50 metres for example) away from the turbine generator. This gives sufficient time lag for prediction of the pressure pulse load on course to impact, and the operation of the turbine generator may be varied in response to the prediction made.

It is preferred that the control means is arranged to derive the flow velocity.

Alternatively, or additionally, the control means may be arranged to determine the predicted loading on the turbine generator as a result of the flow determined.

The control output to the generator is varied in response to the predicted or measured parameter.

In one technique, the control output to the generator is varied in response to the predicted or measured parameter provided a predetermined threshold value is met or exceeded.

In response to the output from the determination means the control means adjusts operating parameters of the turbine generator to moderate stresses that would otherwise act on the system.

In one realisation of the invention, in response to the output from the determination means the control means varies the turbine generator power output or load.

Additionally or alternatively, in response to the output from the determination means the control means varies the turbine generator orientation and or configuration of the turbine rotor blades. For example the blade pitch may be varied.

In one embodiment a plurality of turbine generators are provided (typically mounted on a common seabed structural mounting). Beneficially, the system is arranged to operate such that, in the event of the control means operating to vary operation of one of the turbine generators in response to the output of the determination means, the control means operates to vary operation another of the turbine generators in a compensatory manner.

This provides that the overall output of the system can be maintained at a constant level (or nearer constant than would otherwise be the case if the compensatory variation of turbine operation was not put into effect).

Typically, the tidal turbine generators are seabed mounted at the head of an upstanding mounting structure.

The tidal turbine generators typically have a rotor comprising turbine blades.

According to a further aspect, the invention provides a control system for a tidal flow generation system, the control system comprising flow determination means for determining variations in the flow; the control system operating such that control of the turbine generator may be varied in response to input into the control means from the flow determination means.

For fixed pitch blade designs parameters may be selected or tailored to provide desired operational characteristics. The parameters which may be selected or tailored are the blade stagger angle and/or the Tip Speed Ratio (TSR). The stagger angle refers to the angle of attack or pitch of the blade with respect to the tidal flow direction.

For variable pitch turbines the blade pitch can be varied to vary the operational characteristics of the turbine.

The tidal flow turbine system may include a mounting structure located on the sea bed, the mounting structure being parked in position by its own weight and secured against displacement primarily by frictional contact with the seabed.

In a preferred embodiment, the tidal turbine system includes an interconnected framework structure arranged to rest on the seabed and support a plurality of spaced turbine generators.

The invention will now be described in a specific embodiment, by way of example only, and with reference to the accompanying drawings.

### BRIEF DESCRIPTION OF THE DRAWINGS

FIG. 1 is a schematic representation of a known tidal flow turbine system in accordance with the invention;

FIG. 2 is a schematic representation of a tidal flow energy generation system in accordance with the invention;

FIG. 3 is a schematic representation of an alternative embodiment of tidal flow energy generation system in accordance with the invention.

### DETAILED DESCRIPTION OF THE PREFERRED EMBODIMENTS

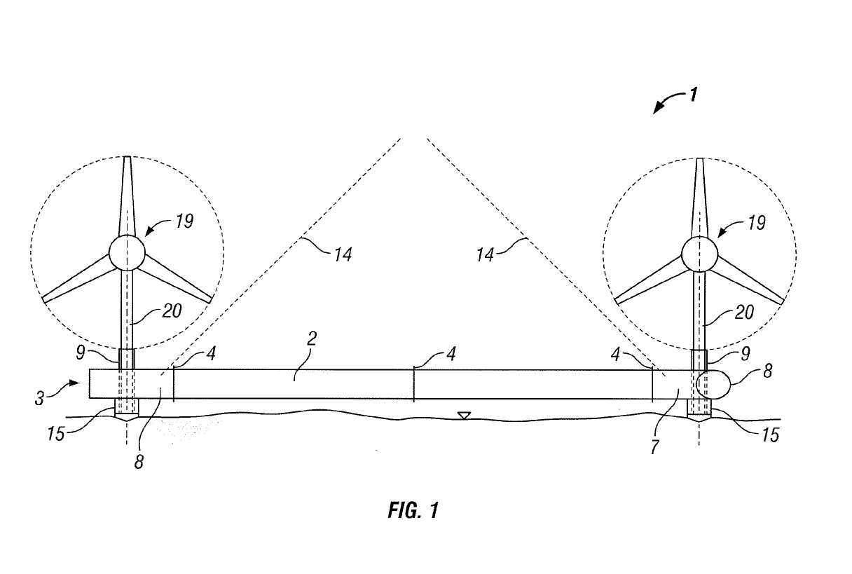

Referring to the drawings, and initially to FIG. 1 there is shown a tidal flow energy generation arrangement 1. The tidal flow energy generation arrangement 1 is required to be operated in extreme conditions. To be commercially competitive with other forms of power production areas of the seabed of high tidal flow energy concentration need to be utilised. These areas are difficult and dangerous to work in and the structure and its installation and retrieval need to take into account significant environmental hazards. The current flow, for example, is fast, typically upward of 4 Knots. Areas are often in deep water, which may be deeper than those in which a piling rig can operate. Storm conditions can cause costly delays and postponement. Tidal reversal is twice a day and the time between tidal reversal may be very short (for example between 15 and 90 minutes). Additionally, in such high tidal flow areas, the seabed is often scoured of sediment and other light material revealing an uneven rock seabed, which makes anchorage difficult. In the situations described it may be impossible for divers or remote operated vehicles to operate on the structure when positioned on the seabed. Installation, recovery and service is therefore most conveniently carried out from the surface. To be environmentally acceptable, all parts of the structure and any equipment used in deployment or recovery must be shown to be recoverable.

The arrangement 1 comprises a freestanding structural frame assembly comprising steel tubes 2 (circa 1.5 m diameter). The frame assembly comprises welded tubular steel corner modules 3. The corner units are interconnected by lengths of the steel tubes 2. The structure as shown in the drawings is triangular in footprint and this may for certain deployment scenarios be preferred however other shape footprints (such as rectangular) are also envisaged in such arrangements the angular configuration of the corner modules 3 will of course be different to that shown and described in relation to the drawings.

The corner modules 3 comprise first and second angled limbs 7, 8 extending at an angle of 60 degrees to one another. The angled tube limb 7 is welded onto the outer cylindrical wall of limb 8. Angled tube limbs 7 and 8 are fixed to a respective nacelle tower 9. The corner module 3 and interconnecting tubes 2 include respective flanges 4 for bolting to one another. The tube limb 8 of the corner modules include a flap valve comprising a hinged flap closing an aperture in a baffle plate welded internally of the end of tube limb 8. Water can flood into and flow out of the tube limb 8 (and therefore into the tubes 2) via the flap valve. Once flooded and in position on the seabed, the flap valve tends to close the end of the tube limb 8 preventing silting up internally of the tubular structure. The corner modules 3 also include a structural steel plate (not shown) welded between the angled tubular limbs 7, 8. A lifting eye structure is welded to the steel plate. An end of a respective chain 14 of a chain lifting bridle arrangement is fixed to the lifting eye. A respective lifting chain 14 is attached at each node module 3, the distal ends meeting at a bridle top link. In use a crane hook engages with the top link for lifting. Self levelling feet 15 maybe provided fore each of the corner modules 3. This ensures a level positioning of the structure on uneven scoured seabed and transfer of vertical loadings directly to the seabed.

The structure is held in position by its own mass and lack of buoyancy due to flooding of the tubes 2 and end modules 3. The tubes 2 are positioned in the boundary layer close to the seabed and the structure has a large base area relative to height. This minimises potential overturning moment. Horizontal drag is minimised due to using a single large diameter tubes 2 as the main interconnecting support for the frame.

The structure forms a mounting base for the turbine generators 19 mounted at each corner module 3, the support shaft 20 of a respective turbine generator 19 being received within the respective mounting tube 3 such that the turbine generators can rotate about the longitudinal axis of the respective support shaft 20. Power is transmitted from the corner mounted turbine generators 19 to onshore by means of appropriate cable as is well known in the marine renewables industry.

Areas of deep water and high current and low visibility are very hazardous for divers. The structure is designed to be installed and removed entirely from surface vessels. The structure is designed to be installed onto a previously surveyed site in the time interval that represents slack water between the ebb and flood of the tide. This time may vary from 15 to 90 minutes.

It has been found that the influence of variations in flow occurring at higher frequencies than the tidal change frequency can have a significant effect. Particularly turbulent flows and flows resulting from wave characteristics can have significant pressure pulse stress loading impact on the structure and the turbine generators 19. Unsteady pressure pulse loading as a result of these effects can cause fatigue in the components of the system which has the potential, if not ameliorated to significantly reduce the operational life of the system. Furthermore if flow velocities vary in an abrupt manner, this can cause the instantaneous turbine operation lead to a stall event.

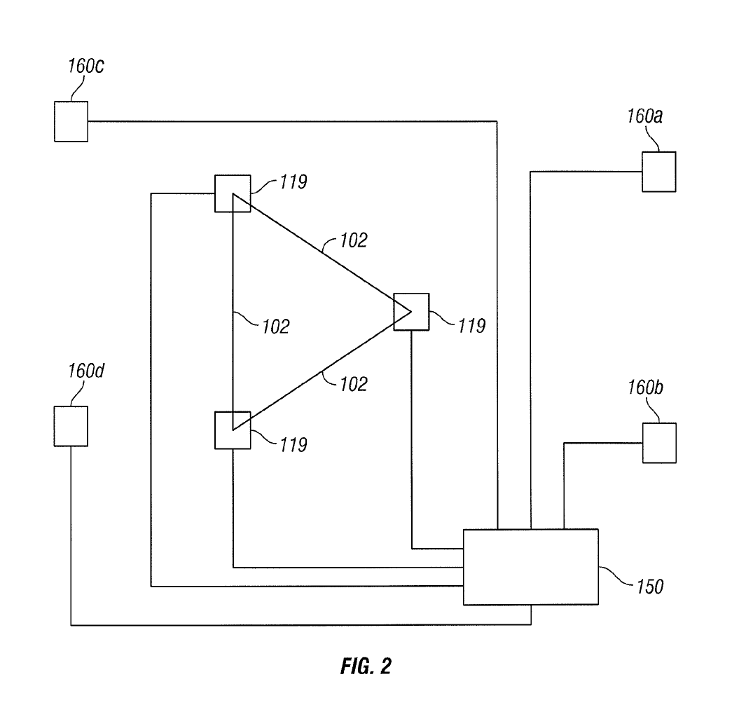

Referring now to the system as shown in FIG. 2, similarly to the embodiment of FIG. 1, the generation system comprises a triangular structural support frame assembly 102 which is mounted on the sea bed. Respective turbine generators 119 are mounted at each apex of the triangular frame 102. Flow determination devices 160a 160b 160c 160d are mounted at strategic positions spaced from the turbine generators 119 and arranged to monitor the flow characteristics (for example one or more of waveform amplitude, pressure, velocity) on course to impact upon the seabed mounted structure and the turbine generators 119. Output from the flow determination devices 160a 160b 160c 160d is directed to the controller 150 which first determines whether the flow variations are significant enough to warrant adjustment of operation of the turbine generators 119. Typically the flow values are compared to threshold values above which the determination is that adjustment of operation of the turbine generators is warranted

Next the controller calculates the required adjustment to the operation of the turbine generators 119. The adjustment is determined to as nearly as possible ensure that the effect of the pressure pulse created loading that is predicted to shortly impact upon one or each of the turbine generators 119 is compensated for, by appropriate variation in operation of the turbine generators (typically by controlling the speed of rotation of the turbine or the load drawn). The effect of fatigue inducing stresses can be neutralised by ascertaining the predicted loading that will shortly be impacting on the turbine generator and by knowing the distance and speed of approach of the anomalous flow effect the time at which the generator operation needs to be varied can be derived by the controller 150 (and also the degree of variation in the operating parameters that is necessary).

In order to make the appropriate adjustment to the operation of the turbine generators 119 (to alter the axial thrust) the output power or load of the turbine generator can be varied (lowered in the case of compensation for incoming increased pressure pulse or wave). For variable pitch blade turbine generators, additionally or alternatively to adjusting the power output or load, the blade pitch may be varied.

The system may be operated such that, in the event of the controller 150 operating to vary operation of one of the turbine generators 119 in response to the output of the flow determination devices 160a 160b 160c 160d, the controller 150 operates to vary operation another of the turbine generators 119 in a compensatory manner. This provides that the overall output of the system can be maintained at a constant level (or nearer constant than would otherwise be the case if the compensatory variation of turbine operation was not put into effect).

The flow determination devices 160a 160b 160c 160d can be sonar or other flow measurement devices. Particularly suitable for use are Acoustic Doppler Current Profiler (ADCP) devices. In the embodiment of FIG. 2 the ADCP devices 160a 160b 160c 160d are located a spaced distance away from the turbine generators 119 and directed upwardly to obtain a velocity profile of a water column at that location. It is beneficially to measure the velocity profile at a sufficient distance (typically ten of metres) away from the turbine generators in order for the turbine generators to have sufficient time to respond to the adjustment control signal from the controller 150.

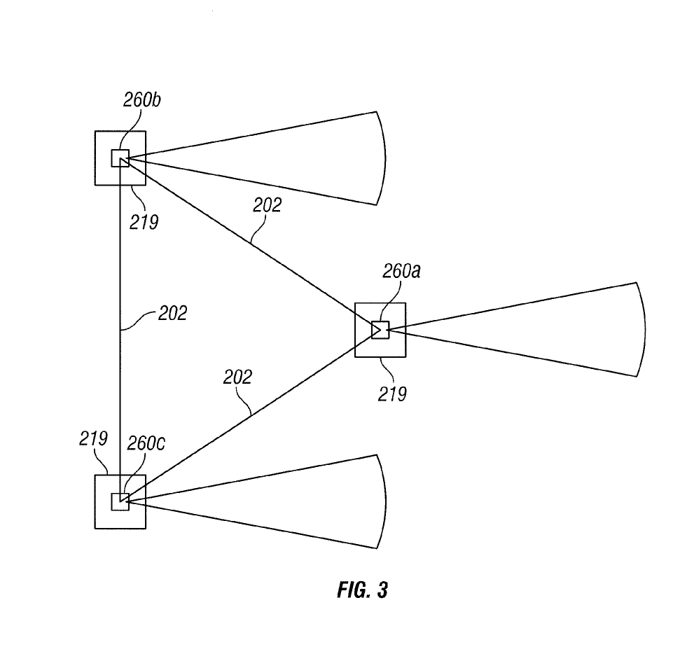

The embodiment of FIG. 3 is generally similar to the embodiment of FIG. 2. The generation system comprises a triangular structural support frame assembly 202 which is mounted on the sea bed. Respective turbine generators 219 are mounted at each apex of the triangular frame 202. In this embodiment however the flow determination devices 260a 260b 260c are mounted on the turbine generators 219 and arranged to monitor the flow characteristics at a fixed distance and in a specific direction (see the measurement cones in FIG. 3) on course to impact upon the seabed mounted structure and the turbine generators 219. Output from the flow determination devices 260a 260b 260c is directed to the controller 250 which first determines whether the flow variations are significant enough to warrant adjustment of operation of the turbine generators 219.

In either embodiment the flow determination devices can be positioned most appropriately for the prevailing flow directions for the relevant tidal flows.

1. A tidal flow energy generation system that converts energy from a tidal flow into electrical energy, comprising:
one or more tidal turbine generators;
control means for controlling operation of the one or more tidal turbine generators; and
flow determination means for determining variations in the tidal flow at a distance spaced from a respective turbine generator in order to predict change in flow characteristics on course to impact on the respective turbine generator;
wherein the control means operates using input from the flow determination means to vary an operational parameter of the respective turbine generator.

2. A system according to claim 1, wherein:
the flow determination means comprises a flow measurement arrangement.

3. A system according to claim 2 wherein:
the flow measurement arrangement comprises a sonar and/or Doppler device.

4. (canceled)

5. A system according to claim 1, wherein:
the control means is arranged to measure flow velocity.

6. A system according to claim 1, wherein:
the control means is arranged to determine predicted loading on the respective turbine generator as a result of the predicted change in flow characteristics on course to impact on the respective turbine generator.

7. A system according to claim 1, wherein:
the operational parameter of the respective turbine generator is varied in response to the predicted change in flow characteristics on course to impact on the respective turbine generator.

8. A system according to claim 7, wherein:
the operational parameter of the respective turbine generator is varied in response to the predicted change in flow characteristics on course to impact on the respective turbine generator provided a predetermined threshold value for the variation in the flow is met or exceeded.

9. A system according to claim 1, wherein:
the operational parameter of the respective turbine generator is varied to moderate stresses that would otherwise act on the system.

10. A system according to claim 1, wherein:
the operational parameter of the respective turbine generator is the power output or load of the respective turbine generator.

11. A system according to claim 1, wherein:
the operational parameter of the respective turbine generator is the orientation and or configuration of the turbine rotor blades of the respective turbine generator.

12. A system according to claim 1, wherein:
a plurality of turbine generators are provided and if the control means operates to vary operation of one of the turbine generators in response to the output of the determination means, the control means operates to vary operation of another of the turbine generators in a compensatory manner.

13. A system according to claim 1, wherein:
the tidal turbine generators are supported on the seabed at the head of an upstanding mounting structure.

14. A system according to claim 1, wherein:
the tidal turbine generators have a rotor comprising turbine blades.

15. A control system for a tidal flow generation system that employs a tidal turbine generator to convert energy from a tidal flow into electrical energy, the control system comprising:
flow determination means for determining variations in the tidal flow; the control system operating such that control of the tidal turbine generator may be varied in response to input into the control means from the flow determination means.

16. A method of operating a tidal flow generation system that employs a tidal turbine generator to convert energy from a tidal flow into electrical energy, the method comprising:
determining pressure pulse variations in the tidal flow at a distance spaced from the tidal turbine generator;
predicting pressure pulse loading that will impact the tidal turbine generator; and
varying operation of the tidal turbine generator to compensate for the predicted pressure pulse loading.
